(19) United States
(12) Patent Application Publication
(10) Pub. No.: US 2001/0013288 A1
(43) Pub. Date: Aug. 16, 2001

(54) Engraved transfer cylinder for a flexographic printing press

(76) Inventors: Wilfried Kolbe, Gulzow (DE); Klaus Schirrich, Bielefeld (DE); Manfred Terstegen, Bielefeld (DE); Bodo Steinmeier, Bielefeld (DE)

Correspondence Address: Richard M. Goldberg, Suite 419, 25 East Salem Street, Hackensack, NJ, 07601, US

(21) Appl. No.: 09/776,098

(22) Filed: Feb. 2, 2001

(30) Foreign Application Priority Data
Feb. 10, 2000 (EP) 00 102 728.3

(51) Int. Cl. B41F 9/00

(52) U.S. Cl. 101/150; 101/153

(57) ABSTRACT

An engraved ink transfer cylinder for a flexographic printing press, wherein the roller body (12) is clamped detachably on a continuous axle (22) and surrounds this axle (22) at a distance.

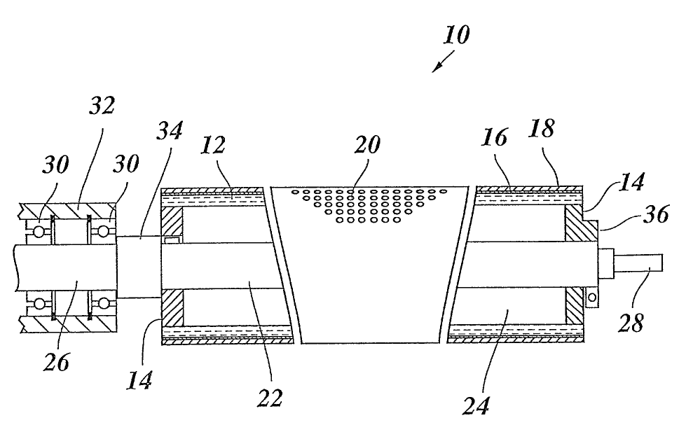

The invention relates to an engraved ink transfer cylinder for a flexographic printing press and to a flexographic printing press with such an engraved ink transfer cylinder.

In flexographic printing presses, engraved ink transfer cylinders take up the printing ink from a chamber doctor blade and transfer it to a impression cylinder rolling along the periphery of the engraved ink transfer cylinder. Until now, such engraved ink transfer cylinders were usually formed by a metal cylinder, which has a ceramic layer on its peripheral surface and in the outer surface of which a fine screen of flat cells is formed, which are filled with printing ink as they pass through the chamber doctor blade and then transfer the printing ink to the impression cylinder. Until now, the bearings have been constructed by axle journals, which are formed in one piece at the two ends of the metal cylinder.

The outer diameter of the impression cylinder depends on the desired printing length. Therefore, if the printing press is to be re-equipped for a new printing process, the impression cylinder usually must be exchanged. The diameter of the engraved ink transfer cylinder does not depend on the desired printing length and generally is smaller than the diameter of the impression cylinder. For different printing orders, however, different engraved ink transfer cylinders are frequently used, which differ in the nature of the cell screen. For this reason, the engraved ink transfer cylinder of a printing press must also be exchanged frequently.

Impression cylinders frequently are constructed as hollow cylinders, which are closed off at both ends; an axle passes through the two ends and the impression cylinder can be clamped hydraulically onto the axle (U.S. Pat. No. 3,378,902). In the European patent application 99 102 033, a impression cylinder is proposed, the outer jacket of which is formed by a casing of a carbon fiber composite material with a rolled framework of carbon fibers. By these means, a saving in weight is achieved without loss of mechanical strength and, with that, the exchanging of the impression cylinder is facilitated.

In the European patent application 98 123 726, a robot is described for exchanging the cylinder of a printing press. By means of this robot, which can be used not only for exchanging the impression cylinder, but also for exchanging the engraved ink transfer cylinder, the cylinder to be exchanged is held only at one end in cantilever fashion. If the sheet of material, which is to be printed, has a very large width and the impression cylinder and engraved ink transfer cylinder must be correspondingly long, large mechanical stresses occur at the holding mechanism of the robot. For this reason, it is also desirable to reduce the weight of the engraved ink transfer cylinder as much as possible.

It is therefore an object of the invention, to provide an engraved ink transfer cylinder, which has the least possible weight for a given mechanical strength.

Pursuant to the invention, this objective is accomplished owing to the fact that the roller body of the engraved ink transfer cylinder is clamped detachably on a continuous axle and surrounds this axle at a distance.

Due to this two-part construction, the weight of the engraved ink transfer cylinder is reduced appreciably. Nevertheless, a high mechanical strength is achieved, since the axle is reinforced by the roller body, which surrounds this axle at a distance. A further advantage of this solution consists therein that the roller body can be detached from the axle and replaced by a different roller body with a different cell screen. During this procedure, the axle can remain in the printing press. In order to make a suitable selection of cell screens possible, it therefore suffices to keep an appropriate assortment of roller bodies in stock, which can then be clamped on to one and the same axle as required. This not only reduces costs, but also decreases the weight of the storage area or storage carriage, used for keeping the assortment of roller bodies.

Advantageous developments of the invention arise out of the dependent claims.

In a particularly preferred embodiment, the roller body is formed by a casing of carbon fiber-containing material, such as a carbon fiber composite material with a rolled framework of carbon fibers. Despite the lesser weight, the carbon fibers give the roller sufficient strength, so that it can surround the axle in cantilever fashion.

Preferably, the roller body is closed off at both ends by disks, which can also be displaced somewhat towards the inside and which can be clamped with their inner peripheral edge on the axle. The disks can be constructed in one piece with the roller body. Alternatively, however, they can also be produced separately from the roller body and from a different material and then connected non-rotationally with the roller body.

In the following, an example is explained in greater detail by means of the drawings.

The FIGURE, containing a single drawing, shows a partially broken open side view of an engraved ink transfer cylinder.

The engraved ink transfer cylinder 10 has a roller body 12 in the form of a tubular casing of a carbon fiber composite material. Such tubular bodies of carbon fiber composite material have previously been used, for example, as sheet-guiding rollers in printing presses or optionally also as impression cylinders for smaller printing lengths. Typically, these tubular bodies have a framework of diagonally wound carbon fibers, which are embedded in a matrix of plastic.

The roller body 12 is closed off in the region of its two ends by disks 14, which consist of metal in the example shown and are connected non-rotationally with the roller body.

On the outer peripheral surface, the roller body 12 carries a metallic primer layer 16, which can be formed by metallizing the carbon fiber composite material. On the primer layer 16, a ceramic layer 18 is applied, on the outer surface of which a fine screen of cells 20 is formed in a known manner.

A continuous axle 22 of metal, the external diameter of which is clearly smaller than the internal diameter of the cylindrical roller body 12, passes through the disks 14. Accordingly, an annular cavity 24 is formed between the axle 22 and the roller body 12. Due to this construction and the slight inherent weight of the roller body 12, the total weight of the engraved ink transfer cylinder is reduced appreciably, so that even relatively long engraved ink transfer cylinders for printing widths of 2000 mm or more can be handled without problems.

At both ends, the axle 24 forms bearing sections 26, 28. The bearing section 26 is held stably in the frame 32 of the flexographic printing press by means of two bearings 30, while the bearing section 28 is held by a removable bearing, which is not shown. After this bearing is removed, the roller body 12 with the disks 14 can be pulled axially from the axle 22.

The axle 22 forms a stop 34 for one of the disks 14, which is wedged non-rotationally with the axle. The disk 14 on the side of the removable bearing is clamped detachably with a clamping bush 36 on the axle 22.

1. An engraved ink transfer cylinder for a flexographic printing press, wherein the roller body (12) is clamped detachably on a continuous axle (22) and surrounds this axle (22) at a distance.

2. The engraved ink transfer cylinder of claim 1, wherein the roller body (12) has a cylindrical casing of carbon fiber-containing material.

3. The engraved ink transfer cylinder of one of the preceding claims, wherein the roller body (12) is closed off at both ends by disks (14), which are clamped onto the axle (22).

4. The engraved ink transfer cylinder of one of the preceding claims, when the outer surface of the roller body (12) has a primer layer (16) of metal and, on this, a ceramic layer (8).

5. A flexographic printing press, with an engraved ink transfer cylinder (10) of one of the claims 1 to 4, wherein the roller body (12) can be pulled axially from the axle (22), which is mounted at one end firmly in the frame (32) of the printing press.
